(19) United States
(12) Patent Application Publication
(10) Pub. No.: US 2024/0399901 A1
(43) Pub. Date: Dec. 5, 2024

(54) MODULAR ELECTRIC CHARGING APPARATUS WITH RECONFIGURABLE TOP

(71) Applicant: Andrew Molle, Irvine, CA (US)

(72) Inventor: Andrew Molle, Irvine, CA (US)

(21) Appl. No.: 18/499,537

(22) Filed: Nov. 1, 2023

Related U.S. Application Data
(63) Continuation-in-part of application No. 18/204,547, filed on Jun. 1, 2023.

(51) Int. Cl. B60L 53/16; B60L 53/30

(52) U.S. Cl. CPC B60L 53/16; B60L 53/30

(57) ABSTRACT

Energy infrastructure systems are contemplated with a raceway with first and second rails or other rows of multiple connection points, first and second cover plates positionally affixed with respect to the first and second rails, a buss extending along at least a portion of the raceway. A first and second current carrying structure is electrically coupled to the buss, where each is configured to carry electrical current through a passageway in a cover plate. A method for updating an electrical infrastructure system, comprising affixing a second distribution hub to the second cover plate, coupling the second distribution hub to draw power from the buss, and moving or replacing the first cover plate with a third second cover plate, such that the third cover plate occupies a different position or length along the raceway. Extruded aluminum modules and hubs for such systems are further contemplated.

This application is a continuation in part of and claims the benefit of priority to U.S. patent application Ser. No. 18/204,547, filed Jun. 1, 2023, which is incorporated by reference in its entirety herein.

### FIELD OF THE INVENTION

The field of the invention is an energy infrastructure system. More particularly, the present energy infrastructure system creates a versatile and upgradable charging and connection platform that can be used with a variety of different providers of vehicle charging systems, battery storage systems, back-up generation systems, and utility grid systems.

### BACKGROUND

The background description includes information that may be useful in understanding the present invention. It is not an admission that any of the information provided herein is prior art or relevant to the presently claimed invention, or that any publication specifically or implicitly referenced is prior art.

Electric vehicles are becoming increasingly popular, and the need to charge different types of vehicles at different locations continues to increase. The development of the charging stations typically involves bespoke planning and construction processes at locations or facilities where a person may park their vehicle for an extended period of time. As the number of vehicles that will be charged increases, the charging stations need to accommodate more and more vehicles with varying charging capabilities. The charging and updating of the different vehicles and charging connectors also needs to accommodate expansion of the industry, along with updates to standalone vehicular charging system hardware. Most vehicle charging stations are manufactured and are permanently installed with a finite number of stations and any upgrades or expansion requires removal of the entire previous system. This can make the charging stations unavailable for a prolonged period while the construction is being performed. A number of patents and or publications have been made issued that address different aspects of the problems. Exemplary examples of patents and or publication that attempt to address this/these problem(s) are identified and discussed below.

U.S. Pat. No. 5,538,361 issued on Jul. 23, 1996 to John V. Beamer and is titled Apparatus for Forming a Trench. This patent discloses a system for forming a single-walled trench comprising a pair of frame members, each having a horizontal section and a section depending from the horizontal section; a collapsing pair of wall pans having sidewalls interior to the depending portion of the frame members, a bottom floor disposed between the sidewalls, a releasing mechanism to collapse inward the sidewalls. While this patent discloses a trench form it does not provide support for internal power transmission.

U.S. Pat. No. 4,145,857 issued on Mar. 27, 1979 to Benjamin L. Tilsen and is titled Base for Mounting Electrical Equipment. This patent discloses a sectionalized structure of preformed wall panels especially adapted for use as base for burial in the earth for mounting above-ground electrical equipment such as sectionalizing cabinets, transformers, electrical switch gear boxes, and similar equipment connected to underground utility cables. This patent seems to merely describe an open cavity without any structure for power transmission out of the cavity. U.S. Pat. No. 262,630 issued on Aug. 15, 1882 to T. N. Vail and is titled Subterranean System of Electrical Conductors. This patent discloses underground wires for electrical systems of communication and improved methods of laying them. This patent is not for power transmission lines and further does not contain buss wiring where connections can be made along the length of the buss wire or strip.

U.S. Pat. No. 343,458 issued on Jun. 8, 1886 to G. S. Hull and is titled Underground Conduit for Electrical Conductors. The object of this invention is to prevent the loss of conductivity which results from the breaking of electrical conductors in test boxes and provides test pins to test the condition of each conductor. This patent does not provide buss wiring or strips to connect electrical power for a charging system. U.S. Pat. No. 11,159,033 issued on Oct. 26, 2021 to A. Molle further describes a modular electric charging apparatus providing a universal base system that can be used to install an electrical power system, with electrical distribution hubs provided from different manufacturers to be connected by electrical wiring into their unique hubs. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

Thus, there remains a need for improved an energy infrastructure system that can be easily upgraded, expanded, and can accommodate different distribution hubs and vehicles.

### SUMMARY OF THE INVENTION

The inventive subject matter provides apparatus, systems, kits, and methods in which an energy infrastructure system comprises a raceway with first and second rails, first and second cover plates positionally affixed with respect to the first and second rails, a buss extending along at least a portion of the raceway, and a first and second current carrying structure electrically coupled to the buss, where each is configured to carry electrical current through a passageway in a cover plate. A method for updating an electrical infrastructure system is also described, comprising affixing a second distribution hub to the second cover plate, coupling the second distribution hub to draw power from the buss, and replacing the first cover plate with the second cover plate, such that the second cover plate extends along the raceway for a different length than the first cover plate.

It is an object of the energy infrastructure system to provide a universal base system that can be used to install electrical power. The universal base allows for cabinets (or electrical distribution hubs) from different manufacturers to connect electrical wiring into their unique cabinet. The cabinet can then connect into a conduit system for distribution to a plurality of vehicle charging locations for distribution. The universal base can have a variety of securing mounts to accommodate different size and shape cabinets and locations for power cable routing into the cabinets as needed for the manufacturer, electrical code and building code.

It is an object of the energy infrastructure system to have an open frame structure for setting and casting concrete around the open frame. The open frame is set level with the desired finished surface with a trench canal and the concrete can be poured into both sides of the cable trench form frame. The open nature of the cable trench form frame allows the concrete to flow around the frame and also sets the frame in the concrete. There is no removal of the frame after the concrete sets and frame is a permanent part of the structure. The frame can further include mounting locations and apparatus that can extend into the poured concrete to provide structural security to above surface mounted housings.

It is another object of the energy infrastructure system to include a support frame and canal that extends from the cabinet base. The canal is easily cut to length or multiple canals can be placed in series for extending the length. This allows for future expansion and room for additional charging stations to be added at the future. The length of the canal can also be extended at a future time without effecting the operation of installed charging stations. An insulated spacer is installed into the support frame to ensure that the canal maintains its shape and provides an electrical connection support system.

It is still another object of the modular energy infrastructure system to include a plurality of buss bar contacts. The buss bars set and/or buss cables and are secured in the insulated spacer. The buss bars extend the length of the canal and provide electrical connection at any point along the length of the canal. This also allows an installer to place a second charging connection to allow vehicles on both sides of the canal. The buss bars can also be extended in the future to provide connections for additional charging stations. The cross-section of the buss bars can also be sized, increased or changed based upon the amount of power that is being used to charge vehicles.

Distribution systems are further contemplated. For example, a system for distributing electricity includes a delivery module with two side units (e.g., opposing), a cover removably coupled between the two side units, an upstream end and a downstream end of the delivery module, and an opening through the cover accessing an interior space of the delivery module. Another (e.g., second) delivery module also includes an upstream and a downstream end, such that the upstream end of the second delivery module is configured to couple with the downstream end of the other (e.g., first) delivery module.

Distribution systems can further include a spanner module configured to separate one delivery module from another, for example by coupling the downstream end of one delivery module with the upstream end of another delivery module. Viewed from another perspective, a spanner module can join the cavity of one delivery module with the cavity of another delivery module, forming a continuous cavity shared by the three modules. One or more conductors pass through the upstream end of the first delivery module, for example to deliver current to the first delivery module or to further pass through the first delivery module to the second or subsequent delivery module(s).

Inventive systems further include one or more electricity delivery hubs. For example, an electricity delivery hub is coupled to the cover of delivery module such that one conductor passes from the delivery module, through the cover, and into the electricity delivery hub. An electricity service module is further coupled with one or more delivery modules and configured to deliver electricity to the system, delivery modules, or electricity delivery hubs. For example, a conductor from the plurality of conductors typically passes from the electricity service module to deliver modules or delivery hubs in the system.

Kits for electrical distribution systems are further contemplated. A side unit has a base surface, an exterior side surface, an interior side surface, a top surface, and a wall extending along the exterior side surface past the top surface. A base coupling is configured to couple the base surface of one side unit with another side unit, preferably at the base surface. A cover is configured to extend between the top surface of one side unit and another side unit, removably coupling to each of the side units. The cover (i) encloses a space between the two side units, (ii) provides an opening to the space between the two side units, or (iii) both. One of the two side units has a mirrored construction of the other side unit, preferably not chiral.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is a perspective view of an energy infrastructure, which comprises a raceway, two electrical distribution hubs supported by individual cover plates, and a post.

FIG. 1B is an alternative, side view of the energy infrastructure, with an electrical distribution hub positioned beneath a cover plate.

FIG. 2 depicts a perspective view of an energy infrastructure, which comprises a raceway, and an electrical distribution hub supported by multiple cover plates.

FIG. 3 is a perspective view of an alternative energy infrastructure having a electrical distribution hub supported by an individual cover plate, another electrical distribution hub supported by multiple cover plates, and a spacer cover plate.

FIG. 4 depicts an energy distribution system of the inventive subject matter.

FIG. 5 is a cutaway view of part of an energy distribution system of the inventive subject matter.

FIG. 6 is a perspective view of part of a framework for an energy distribution system of the inventive subject matter.

FIG. 7A depicts a view of a side unit of modules of the inventive subject matter.

FIG. 7B depicts a view of another side unit of modules of the inventive subject matter.

FIG. 8 depicts a post of used in systems of the inventive subject matter.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Distribution systems are contemplated. For example, a system for distributing electricity includes a delivery module with two side units (e.g., opposing), a cover removably coupled between the two side units, an upstream end and a downstream end of the delivery module, and an opening through the cover accessing an interior space of the delivery module. Another (e.g., second) delivery module also includes an upstream and a downstream end, such that the upstream end of the second delivery module is configured to couple with the downstream end of the other (e.g., first) delivery module.

The first side unit, second side unit, and cover of one or more, or all, of the delivery modules typically enclose an internal cavity. Coupling one delivery module with another delivery module, for example via upstream and downstream ends, joins the cavity of each delivery module with the other.

Distribution systems can further include a spanner module configured to separate one delivery module from another, for example by coupling the downstream end of one delivery module with the upstream end of another delivery module. Viewed from another perspective, a spanner module can join the cavity of one delivery module with the cavity of another delivery module, forming a continuous cavity shared by the three modules. Spanner module(s) typically include two side units (e.g., opposing) and a cover removably coupled between the two side units.

One or more conductors pass through the upstream end of the first delivery module, for example to deliver current to the first delivery module or to further pass through the first delivery module to the second or subsequent delivery module(s). One or more of the plurality of conductors typically extends between one or more, or all, of the delivery modules in the distribution system, for example via spanner module(s), adjacent delivery modules, or both. For example, where the inventive system includes two delivery modules, at least one conductor from the plurality of conductors extends between the two delivery modules.

Inventive systems further include one or more electricity delivery hubs. For example, an electricity delivery hub is coupled to the cover of delivery module such that one conductor passes from the delivery module, through the cover, and into the electricity delivery hub. Where the system includes multiple electricity delivery hubs, for example another electricity delivery hub coupled to the cover of another delivery module, an additional (e.g., second) conductor from the plurality of conductors passes through the cover of the delivery module and into the additional electricity delivery hub.

Systems of the inventive subject matter further include an electricity service module coupled with one or more delivery modules and configured to deliver electricity to the system, delivery modules, or electricity delivery hubs. For example, a conductor from the plurality of conductors typically passes from the electricity service module to deliver modules or delivery hubs in the system.

Side units included in one or more delivery modules, or one or more spanner modules, are at least 75% or 90% aluminum, in some embodiments 100% aluminum (e.g., extruded aluminum), though compositions including other metals or alloys are contemplated. In some embodiments the entirety, or at least 50% or 75%, of delivery modules or spanner modules, or both, is composed of aluminum (e.g., extruded aluminum).

In some embodiments, side units of delivery modules or spanner modules each include a guide extending along an exterior surface of the side unit, with the guides abutting the cover coupled with the module. The two side units of a delivery module are formed such that one side unit mirrors the other, but preferably are not chiral. Similarly, at least two, but preferably most or all, of the delivery modules in a system of the inventive subject matter have the same structure. The side units of delivery or spanner modules, as well as their corresponding covers, have a length between 1 foot and 3 feet and typically varying by 1 foot increments, with the side units of the same module (and in some embodiments the corresponding cover) having the same length dimension.

One or more of the delivery modules also include a foundation coupling configured to secure the delivery module to a foundation surface, for example pavement, slabs, pillars, anchors, or other surfaces. The delivery modules can further include a base tie configured to couple the base of one side unit to the base of another side unit of the same, or adjacent, delivery modules.

Kits for electrical distribution systems are further contemplated. A side unit has a base surface, an exterior side surface, an interior side surface, a top surface, and a wall extending along the exterior side surface past the top surface. A base coupling is configured to couple the base surface of one side unit with another side unit, preferably at the base surface. A cover is configured to extend between the top surface of one side unit and another side unit, removably coupling to each of the side units. The cover (i) encloses a space between the two side units, (ii) provides an opening to the space between the two side units, or (iii) both. One of the two side units has a mirrored construction of the other side unit, preferably not chiral.

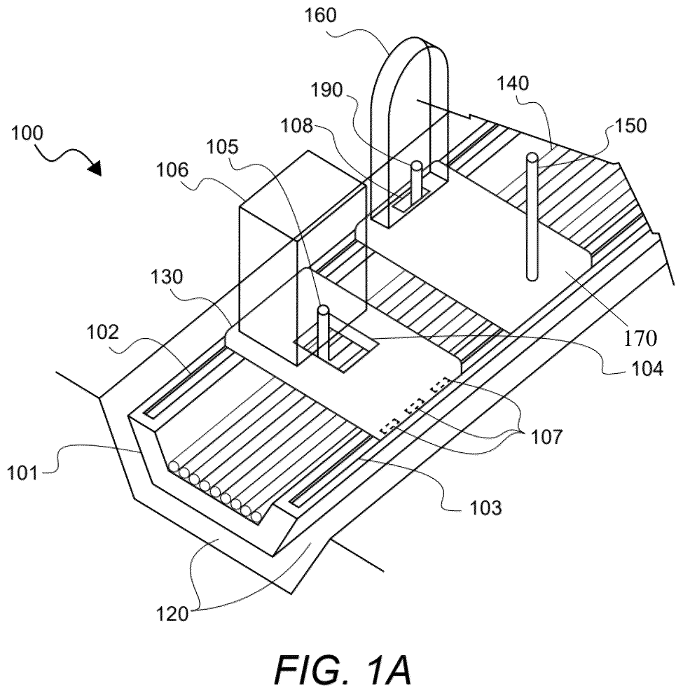

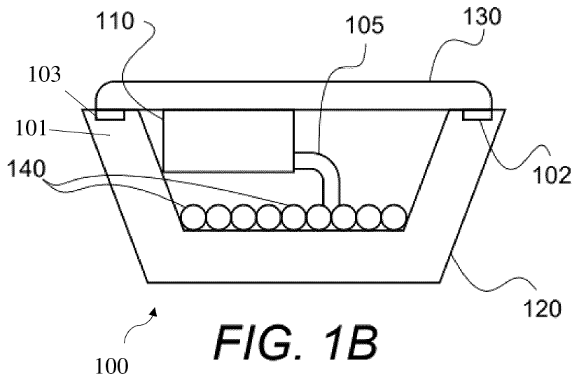

FIG. 1A shows a perspective view of an energy infrastructure 100, which comprises a raceway 101 having electrical distribution hubs 106 and 160 supported by cover plates 130 and 170, respectively, and positionally affixed with respect to first rail 102 and a second rail 103. Raceway 101 is at least partially positioned within a trench 120, and further includes a buss 140 extending along at least a portion of raceway 101.

Cover plate 130 is removably coupled with first rail 102 and second rail 103 via fasteners 107. In a related embodiment, cover plate 130 has a thickness of at least 5 mm. Cover plate 130 comprises at least one of a metal (e.g., steel, aluminum, extruded metals, etc.), concrete, and a resin composite. Cover plate 130 includes a passageway 104, where current carrying structure 105 carries electrical current through the passageway 104 in cover plate 130. Cover plate 130 is removably coupled with first rail 102 and second rail 103 via fasteners 107. In a preferred embodiment, fasteners 107 are a clip. In a related embodiment, fastener 107 is a bolt. In other embodiments, fastener 107 is an adhesive.

In a preferred embodiment, current carrying structure 105 is configured to provide electrical current to an electrical distribution hub 106 from the buss 140. In the depicted embodiment, the passageway 104 of cover plate 130 is sized and dimensioned to at least partially extend beyond the footprint of electrical distribution hub 105. Cover plate 170 is also removably coupled with first rail 102 and second rail 103 via fasteners similar to or the same as fasteners 107. Cover plate 170 includes a passageway 108, where current carrying structure 190 carries electrical current through the passageway 108 in cover plate 170. Cover plate 170 further includes a post 150 positionally affixed with respect to the cover plate 170. Advantageously, post 150 is positioned to obstruct electrical distribution hub 160 from vehicular incursion on or over cover plate 170. In a preferred embodiment, cover plate 130 and cover plate 170 occupy different lengths along first rail 102 and a second rail 103, respectively. It is further contemplated that both the cover plate 130 and cover plate 170 are slidable along the first rail 102 and a second rail 103.

In some embodiments, passageway 108 is sized and dimensioned to at least partially extend beyond the footprint of electrical distribution hub 160. In a preferred embodiment, current carrying structure 190 is configured to provide electrical current to an electrical distribution hub 160 from the buss 140. In a related embodiment, the electrical distribution hub 160 is different than the electrical distribution hub 106 by a width, length, height, or weight rating. In another embodiment, the electrical distribution hub 160 is a different model than the electrical distribution hub 106. In a related embodiment, the energy infrastructure 100 has a weight preferably between 300 kg and 1000 kg and even up to 5000 kg. In a preferred embodiment, current carrying structure 105 or 190 comprises a metal containing bar, metal fiber, or metal wire.

FIG. 1B shows a side view of energy infrastructure 100, which comprises a raceway 101 having a first rail 102, a second rail 103, and an electrical distribution hub 110 positioned below cover plate 130 and positionally affixed with respect to first rail 102 and a second rail 103. Cover plate 130 includes a passageway 104 (not shown), where current carrying structure 105 carries electrical current through the passageway 104 in cover plate 130 via electrical distribution hub 110. Cover plate 130 is removably coupled with first rail 102 and second rail 103 via fasteners (not shown). In a preferred embodiment, electrical distribution hub 110 is positioned such that at least some of a weight of the hub 106 is supported by cover plate 130.

Cover plate 130 is removably coupled with first rail 102 and second rail 103 via fasteners (not shown). In a preferred embodiment, electrical distribution hub 110 is positioned such that at least some of a weight of the hub 106 is supported by cover plate 130. In a related embodiment, electrical distribution hub 110 is cantilevered with respect to cover plate 130.

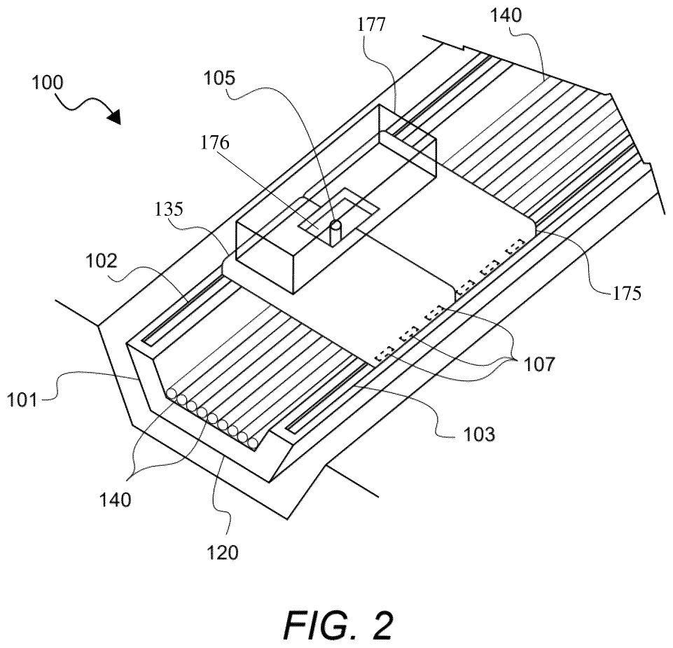

FIG. 2 shows an alternative embodiment of energy infrastructure 100, which comprises a raceway 101 having a first rail 102, a second rail 103, and an electrical distribution hub 177 positioned above cover plates 135 and 175. Cover plates 135 and 175 are positionally affixed with respect to first rail 102 and a second rail 103, and are removably coupled via fasteners 107. Cover plates 135 and 175 further include a shared passageway 176, where current carrying structure 105 carries electrical current through the passageway 176 to electrical distribution hub 177.

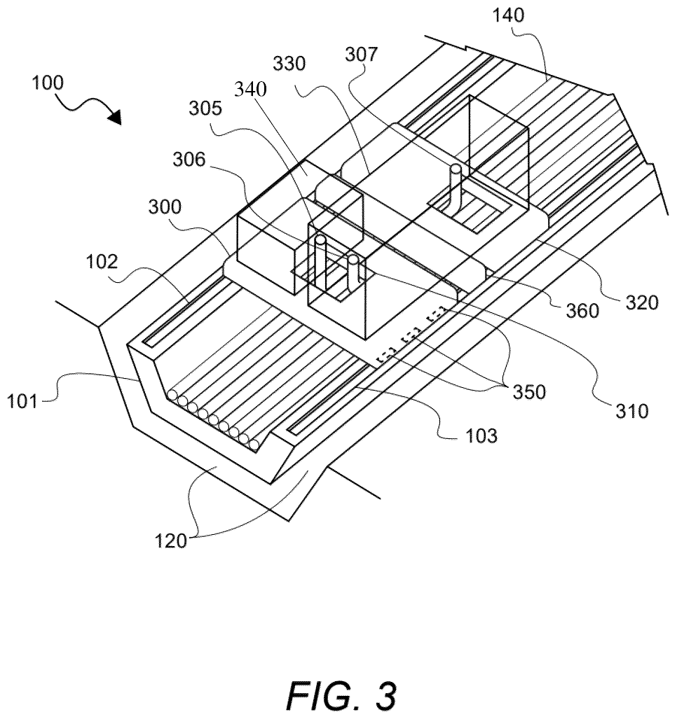

FIG. 3 depicts another embodiment of energy infrastructure 100, which

comprises a raceway 101 having electrical distribution hub 340 supported by cover plate 300, and electrical distribution hub 330 supported by cover plate 300 and 320. Raceway 101 further includes a spacer cover plate 360, disposed between cover plates 300 and cover plate 320. Cover plate 300 includes a passageway 310, where current carrying structures 305 and 306 carry electrical current through the passageway 310 in cover plate 300.

Cover plate 300 is affixed to and extends along the raceway 101 for a first length, where electrical distribution hub 340 is affixed to cover plate 300 and configured to draw power from buss 140 via current carrying structure 305. Electrical distribution hub 330 is affixed to cover plates 320 and 300, and coupled to the electrical distribution hub 330 to draw power from the buss 140 via current carrying structures 306 and 307, respectively. In a preferred embodiment, cover plate 320 replaces cover plate 300, such that the cover plate 320 extends along the raceway 101 for a second length different from the first length.

In the depicted embodiment, the cover plate 320 is shorter than the cover plate 300, and spacer cover plate 360 is installed in the raceway 101 to make up for a difference in length between the cover plates 320 and 300. In preferred embodiments, size of cover plate 320 is adjusted to accommodate a change in width of a parking space for a vehicle. In some embodiments, electrical distribution hub 305 is a different model from electrical distribution hub 330.

In some embodiments, various components of the inventive subject matter comprise or are composed of concrete, metal (e.g., steel, aluminum, extruded metal, extruded aluminum, etc.), insulators, rubber, or resin, in whole or in part and combinations thereof. For example, features such as raceway 101, hubs 106, 160, 177, 330, or 340, cover plates 130, 135, 170, 175, 300, or 320, space cover plate 360, rails 102 or 103, post 150, or trough 120 or their analogs/replacements can be made of aluminum, preferably extruded aluminum.

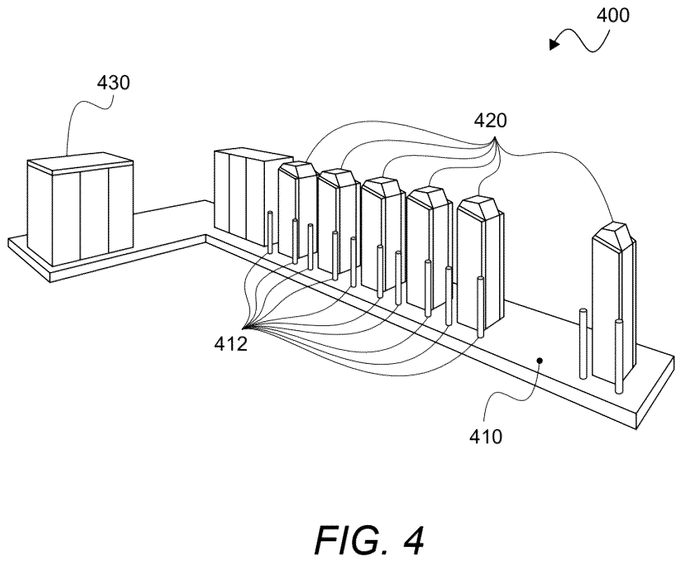

FIG. 4 depicts energy distribution system 400. Delivery modules 410 are formed of side units and covers of the inventive subject matter, with each delivery module connected to neighboring delivery modules. Here the modules are connected in a row, but further geometries including branched rows and columns are also contemplated as may be suitable to accommodate multiple electricity delivery points such as to charge electric vehicles in a parking lot.

Poles 412 and electricity delivery hubs 420 are coupled to delivery modules 410, for example at the top surface of the module. Poles 412 typically act as barriers to prevent damage to modules 410 or hubs 420. Each, or at least most, of hubs 420 are coupled with a conductor (not shown) from each respective module 410. The conductors in each module 410 are sourced from, or at least energized by, service hub 430. For example, a conductor coupled to a specific hub 420 typically runs from the specific hub 420, through the coupled hub 410 and intervening hubs 410 to service hub 430.

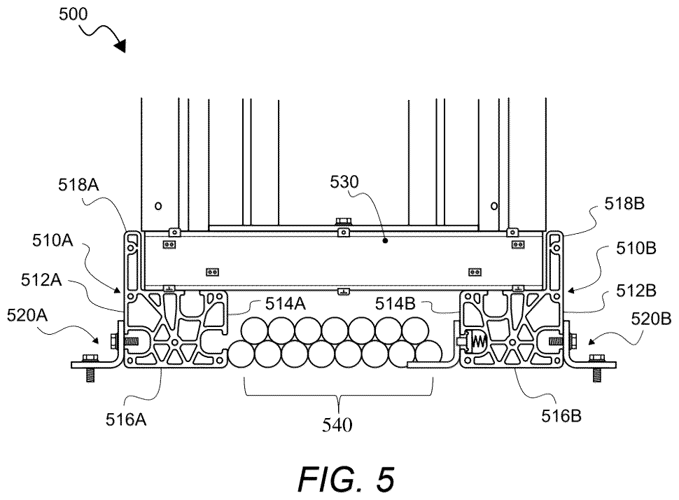

FIG. 5 depicts a cut away view of delivery hub 500, including side units 510a and 510b, couplings 520a and 520b, cover 530, and conductor cables 540. Side unit 510a includes exterior wall 512a, interior wall 514a, base 516a, and guide 518a. Side unit 510a further includes recesses along walls 512a and 514a, as well as a top surface of the side unit. Such recesses are used to couple the side unit to nearby side units, foundations, or other elements of the systems of the inventive subject matter. For example, coupling 520a (bracket with screws or bolts) is connected to a recess of wall 512a and a foundation (not shown), securing delivery hub 500 in place.

Side unit 510b and coupling 520b have the same features as described for side unit 510a and coupling 520a. Viewed from one perspective, side unit 510a and side unit 510b are similar, with side unit 510a a left hand configuration of a side unit and side unit 510b a right hand configuration of the same side unit. Side units 510a and 510b are typically made of extruded aluminum.

Cover 530 extends between guides 518a and 518b of the respective side units and serves to couple the side units together. Cover 530 further encloses an interior space between the two side units. As otherwise depicted, cover 530 further provides access for one of conductor cables 540 to engage with a hub coupled to cover 530 (e.g., electricity delivery hub). Not shown, side units 510a and 510b are further coupled by a base coupling between interior surfaces 514a and 514b, or bases 516a and 516b, or both.

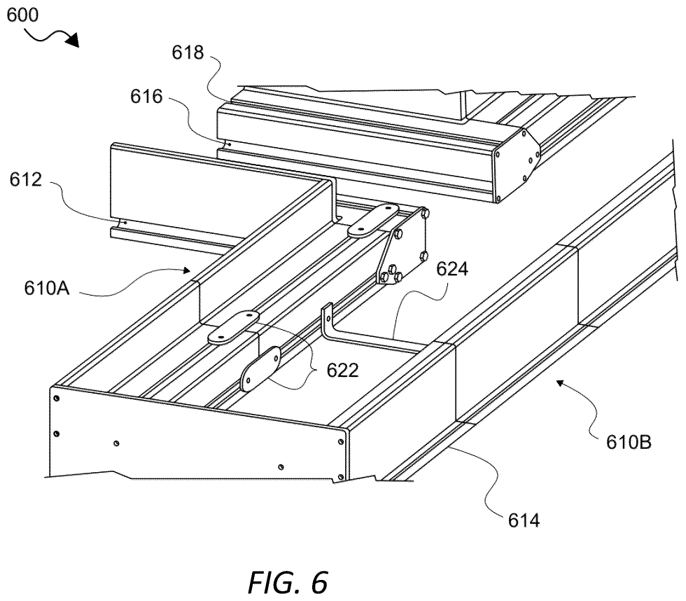

FIG. 6 is a perspective view of framework 600, including side units 610a and 610b and a plurality of similar side units coupled together in a top-down “T” configuration. Side units 610a and 610b are typically extruded aluminum, formed in 1, 2, or 3 foot segments.

Recesses 612, 614, 616, and 618 can have the same shape and form grooves on the surfaces of side units 610a, 610b, and the plurality of side units, for example recesses 612 and 614 forming grooves on the exterior side surface, recess 616 forming a groove on an interior side surface, and recess 618 forming a groove on a top surface of the side units. Couplings 622 engage with such recesses to couple abutting side units, while base coupling 624 couples opposing side units. It is contemplated conductors are placed in the space (e.g., channel or trough) between opposing side units, with covers then placed over and between opposing side units to shield the interior space of the side units and provide access to the conductors where intended for delivery hubs. Further trim pieces can be added to framework 600 to fill gaps or spaces, or otherwise proof the framework to distribute electricity to delivery hubs (e.g., water proofing, thermal proofing, dust proofing, EM field proofing, etc.).

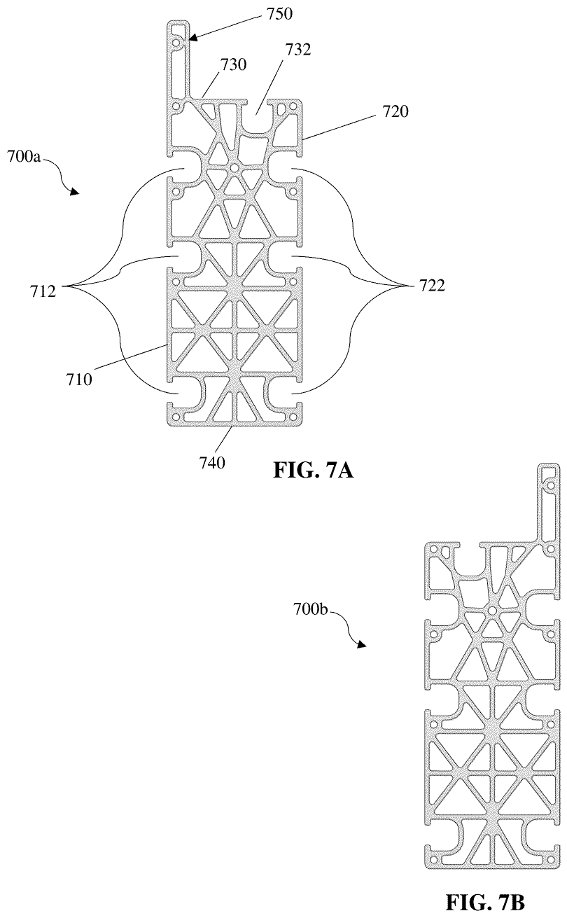

FIG. 7A is a cut away view of side unit 700a of the inventive subject matter. Side unit 700a is preferably made of extruded aluminum, though other appropriate aluminum fabrication methods, as well as additional metals, alloys, or combinations for such fabrication, can be used.

Side unit 700a includes exterior side surface 710, interior side surface 720, top surface 730, and bottom surface 740. Exterior surface 710 and interior surface 720 include recesses 712 and 722, respectively, extending along the each surface, and are generally used for coupling, for example using nuts/bolts or clips. Recesses 712 and 722 can be used to attach side unit 700a to a foundation or ground support (e.g., abutting or below bottom surface 740), can be used to couple side unit 700a to other units nearby (e.g., abutting, adjacent, opposing, etc.) having similar structures, as well as to attach additional components or items to side unit 700a. While three recesses each of 712 and 722 features are depicted, it is contemplated that 1, 2, 3, or more, for example up to 10, recesses on each side, or one side, can be included.

Top surface 730 also includes recess 732, which is typically used to couple side unit 700a with nearby side units. Side unit 700a also includes guide 750 extending along surface 710 from top surface 730. Side unit 700a is typically coupled with a cover as depicted in FIG. 5, for example. Such covers typically fit flush against guide 750, with guide 750 serving as a constraint on a cover and optional coupling point.

FIG. 7B depicts side unit 700b having features noted with respect to side unit 700a in FIG. 7A. Side units 700a and 700b are similar in structure, and from one perspective can be viewed as left hand (700a) and right hand (700b) configurations of side units of the inventive subject matter. Side units 700a and 700b are coupled together to form delivery or spanner hubs of the inventive subject matter.

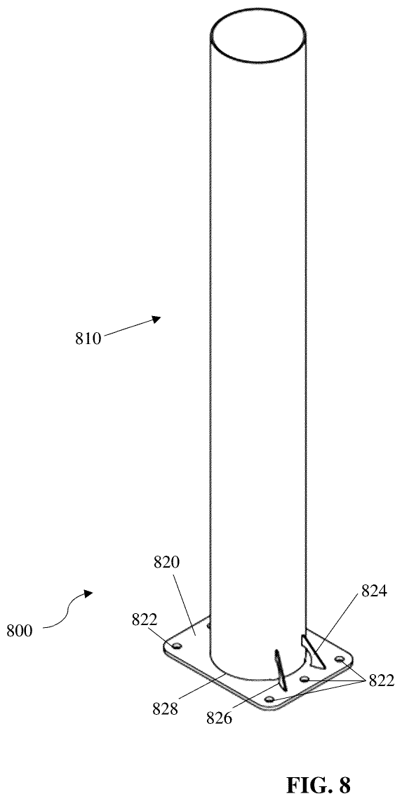

FIG. 8 depicts pole unit 800, which can be used with systems or devices of the inventive subject matter, for example as pole 412 of FIG. 4. Pole, post, or bollard unit 800 includes post 810 coupled to mounting plate 820. Post 810 is intended to protect hardware of energy distribution systems from damage, for example from moving vehicles near electric vehicle charging stations. Post 810 can be made completely or partially of metal (e.g., steel), concrete, reinforced concrete, polymers, or combinations thereof.

Post 810 is coupled to mounting plate 820 by tabs 824 and 826, by a weld, adhesive, or other bond between mounting plate 820 and post 81 along seam 828, or by both tabs and a bond. For example, a seam weld can form a continuous weld around seam 828, a partial circumference of seam 828 (e.g., minor arc along seam 828 between tabs 824 and 826, major arc along seam 828 between tabs 824 and 826, less than 45°, 60°, 90°, 180°. 270°, or 360° of along seam 828, etc.). Mounting plate 820 coupled to a cover of an energy distribution system (e.g., cover 530) via connectors (e.g., bolts) through holes 822.

Tabs 822 and 824 are coupled (e.g., by weld, adhesive, fusing, casting, etc.) to post 810 and mounting plate 820. Tabs 822 and 824 are preferably “break away” tabs, configured to maintain coupling between post 810 and mounting plate 820 up to a specified load, moment, or stress on post 810, up to a failure point. Once the failure point is reached, tabs 822 and 824, coupling between tabs 822 and 824 and post 810, coupling between tabs 822 and 824 and mounting plate 820, or a combination thereof, break or sever. The failure point is typically a load, moment, or stress of at least 1000 foot-pound (ft-lbs) of force applied against post 810 parallel to the plane of seam 828 (e.g., horizontal force vector), or at least 2000 ft-lbs, 3000 ft-lbs, 3500 ft-lbs, 3700 ft-lbs, 4000 ft-lbs, or more than 4500 ft-lbs.

By introducing a failure point along seam 828 and tabs 824 and 826, forces exceeding the failure point separate post 820 from mounting plate 820, and the remainder of the energy distribution system. This prevents damage to the energy distribution system while providing direct replacement of individual damaged posts 810. For example, an damage from an electrical vehicle backing or driving into post 810 is blocked by post 810 and, if the force of the vehicle exceeds the failure point of tabs 824, 826, the bond at seam 828, or combinations thereof, post 810 separates from mounting plate 820 instead of damaging the underlying cover or hardware of the energy distribution sytem.

As used herein, and unless the context dictates otherwise, the term “attached to” and “coupled to” are intended to include both direct coupling (in which two elements that are coupled to each other contact each other) and indirect coupling (in which at least one additional element is located between the two elements). Therefore, the terms “attached to,” “coupled to,” “attached with,” and “coupled with” are used synonymously.

Additional Contemplated claims
20. An energy infrastructure comprising:
   a series of potential connection points;
   first and second cover plates configured to be removably positioned along the series of potential connection points;
   a buss extending along a raceway;
   a first current carrying structure electrically coupled to the buss, and configured to carry electrical current through a first passageway in the first cover plate; and
   a second current carrying structure electrically coupled to the buss, and configured to carry electrical current through a second passageway in the second cover plate.
21. The energy infrastructure of claim 20, wherein the raceway is at least partially positioned within a trench.
22. The energy infrastructure of claim 20, wherein the first and second cover plates are configured to be removably positioned along the series of potential connection points using at least one of a clip and a bolt.
23. The energy infrastructure of claim 20, further comprising a first electrical distribution hub configured to communicate power with the first current carrying structure, the first electrical distribution hub positioned such that at least some of a weight of the electrical distribution hub is supported by the first cover plate.
24. The energy infrastructure of claim 23, where first electrical distribution hub is positioned above the first cover plate.
25. The energy infrastructure of claim 23, where first electrical distribution hub is positioned below the first cover plate.
26. The energy infrastructure of claim 4, where first electrical distribution hub is cantilevered with respect to the first cover plate.
27. The energy infrastructure of claim 20, further comprising first and second electrical distribution hubs supported by the first and second cover plates, respectively, and wherein the first electrical distribution hub has a different design from the second electrical distribution hub.
28. The energy infrastructure of claim 20, further comprising a first electrical distribution hub configured to receive power from the first current carrying structure, the first electrical distribution hub having a weight of between 300 kg and 1000 kg.
29. The energy infrastructure of claim 20, wherein the first cover plate has a different weight rating than the second cover plate.
30. The energy infrastructure of claim 20, wherein the buss comprises a metal containing bar.
31. The energy infrastructure of claim 20, wherein the first and second cover plates occupy different lengths along the series of potential connection points.
32. The energy infrastructure of claim 20, further comprising a post positionally affixed with respect to the first cover plate.
33. The energy infrastructure of claim 20, further comprising a spacer cover plate not passing current from the buss.
34. The energy infrastructure of claim 20, wherein the series of potential connection points comprise continuous positions along a rail.
35. A method for updating an electrical distribution system having electric current distribution line positioned within a raceway, the method comprising:
   affixing a first cover plate to a first position relative to the raceway, and a first distribution hub to the first cover plate,
   affixing a second cover plate to a second position relative to the raceway, and a second distribution hub to the second cover plate,
   configuring the first and second distribution hubs to receive from or provide power to the current distribution line; and
   moving the first cover plate to a third position relative to the raceway, wherein the third position is different from the first position.
36. The method of claim 35, further comprising first and second rails, and wherein the step of moving the first cover plate comprises sliding the first cover plate along the first and second rails.
37. The method of claim 35, further comprising placing a spacer cover plate between the first and second rails following moving of the first cover plate.
38. A method for updating an electrical distribution system having electric current distribution line positioned within a raceway, the method comprising:
   affixing first and second cover plates relative to the raceway;
   affixing first and second distribution hubs to the first and second cover plates, respectively; and
   replacing the first cover plate with a third cover plate having a different length along the raceway than the first cover plate.
39. The method of claim 38, further comprising placing a spacer cover plate between the second rails and third cover plates.
40. The method of claim 38, wherein the first and third cover plates occupy different lengths along the raceway, and further comprising selecting the length of the third plate to accommodate a change in width of a parking space for a motor vehicle.

It should be apparent to those skilled in the art that many more modifications besides those already described are possible without departing from the inventive concepts herein. The inventive subject matter, therefore, is not to be restricted except in the spirit of the amended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

What is claimed is:

1. A distribution system for electricity, comprising:
a first delivery module having a first and a second side unit, a cover removably coupled between the first and the second side unit, an upstream end, a downstream end, and an opening through the cover;
a second delivery module having an upstream end and a downstream end, wherein an upstream end of the second delivery module is configured to couple with the downstream end of the first delivery module; and
a plurality of conductors passing through the upstream end of the first delivery module.

2. The system of claim 1, wherein the first side unit, second side unit, and cover of the first delivery module enclose a first cavity.

3. The system of claim 1, wherein coupling the first delivery module with the second delivery module joins a cavity of the first delivery module with a cavity of the second delivery module.

4. The system of claim 1, further comprising a spanner module configured to couple the downstream end of the first delivery module with the upstream end of the second delivery module.

5. The system of claim 4, wherein the spanner module comprises a first side unit, a second side unit, and a cover removably coupled between the first and the second side unit.

6. The system of claim 4, wherein at least one of the plurality of conductors extends from the first delivery module to the second delivery module via the spanner module.

7. The system of claim 1, wherein at least one of the plurality of conductors extends from the first delivery module to the second delivery module.

8. The system of claim 1, further comprising a first electricity delivery hub coupled to the cover of the first delivery module, and a first conductor passing through the cover of the first delivery module and into the first electricity delivery hub.

9. The system of claim 1, wherein the first and the second side units of the first delivery module are at least 75% aluminum.

10. The system of claim 1, wherein the first and the second side units each comprise a guide extending along an exterior surface of each side unit.

11. The system of claim 10, wherein the cover of the first delivery module abuts each guide of the first and second side units.

12. The system of claim 1, wherein the first side unit of the first delivery module mirrors the second side unit of the first delivery module.

13. The system of claim 1, wherein the second delivery module has a structure duplicating the first delivery module.

14. The system of claim 8, further comprising a second electricity delivery hub coupled to the cover of the second delivery module, and a second conductor passing through a cover of the second delivery module and into the second electricity delivery hub.

15. The system of claim 1, further comprising an electricity service module coupled with the first delivery module and configured to deliver electricity to the system, wherein at least one of the plurality of conductors passes from the electricity service module to the first deliver module.

16. The system of claim 1, wherein the first delivery module further comprises a foundation coupling configured to secure the first delivery module to a foundation surface.

17. The system of claim 1, further comprising a base tie configured to couple a base of the first and the second side unit of the first delivery module.

18. The system of claim 1, wherein the first side unit of the first delivery module has a length between 1 foot and 3 feet, and wherein the cover has a length between 1 foot and 3feet.

19. A kit for an electrical distribution system, comprising:
a first side unit having a base surface, an exterior side surface, an interior side surface, a top surface, and a wall extending along the exterior side surface past the top surface;
a base coupling configured to couple the base surface of the first side unit with a second side unit; and
a cover configured to extend between the top surface of the first side unit and the second side unit, the cover further configured to removably couple to the first side unit and the second side unit;
wherein the cover is configured to one of (i) enclose a space between the first side unit and the second side unit, or (ii) provide an opening to the space between the first side unit and the second side unit.

20. The kit of claim 1, wherein the second side unit has mirrored construction to the first side unit.
